(19) United States
(12) Patent Application Publication
(10) Pub. No.: US 2007/0118274 A1
(43) Pub. Date: May 24, 2007

(54) Telematics application protocol along with devices, systems and methods employing the same

(75) Inventor: Angela Orebaugh, Charlottesville, VA (US)

Correspondence Address: BUCHANAN, INGERSOLL & ROONEY PC, POST OFFICE BOX 1404, ALEXANDRIA, VA, 22313-1404, US

(73) Assignee: Sytex, Inc.

(21) Appl. No.: 11/496,722

(22) Filed: Aug. 1, 2006

Related U.S. Application Data
(60) Provisional application No. 60/704,756, filed on Aug. 1, 2005.

(51) Int. Cl. G06F 17/00

(52) U.S. Cl. 701/117; 701/2

(57) ABSTRACT

Provided is a telematics application protocol (TAP) which extends the automotive telematics arena by providing a communications framework for applications which allow a user to communicate with a vehicle's onboard processor. Using the TAP, communication is accomplished via a suitable computational device, such as a PDA or a laptop computer, to query for vehicle information and control sensors thereby providing an ability, for instance, to monitor and/or manage onboard automotive diagnostics and functionalities.

This application claims priority under 35 U.S.C. §119 of U.S. Provisional Application No. 60/704,756 (Attorney Docket No. 2173), filed Aug. 1, 2005. The entire contents of the above provisional application are hereby incorporated by reference.

### BACKGROUND

Over the years, the term “telematics” has evolved from a broad connotation referring to the convergence of computers and telecommunications to a more focused connotation dealing with automotive applications. Most definitions of telematics involve the exchange of data, the use of applications, location devices, and monitoring. The field of “automotive telematics”, in particular, is a growing area of technology and much research in the arena has focused on the interaction between the vehicle and the telematics service provider (TSP). Current automotive telematics applications include vehicle-based electronic systems, mobile telephony, vehicle tracking and positioning, online navigation and information services, and emergency assistance.

For example, the OnStar® service developed by the General Motors corporation integrates GPS with roadside assistance and remote diagnostics. In its implementation the OnStar® system, as well as other automotive telematics applications, utilizes a central telematics service provider (TSP) for interacting directly with the vehicle. For example, U.S. Pat. No. 6,687,587 discloses a telematics system in which call centers transmit software to a telematics module on a vehicle, to program or update control modules on the vehicle. The foregoing examples of the related art and its related limitations are intended to be illustrative and not exclusive. It is believed that current TSP services only provide communications between the TSP and the vehicle, and no products or services are known to the inventor which allow an individual user to interact with the vehicle from a remote location for the purpose of monitoring and/or managing onboard automotive sensors and information.

### SUMMARY

Provided is a telematics application protocol (TAP) which extends the automotive telematics arena by providing a communications framework for applications which allow an individual user to communicate with a vehicle's onboard processor. Using the TAP, communication is accomplished via a personal computational device, such as a PDA or a laptop computer, to query for vehicle information and control sensors, thereby providing an ability to monitor and/or manage onboard automotive diagnostics and functionalities, for example. The TAP operates in a client/server architecture to allow a user, presumably the owner of the vehicle or an authorized individual, to interact with the vehicle via the computational device. The physical medium is abstracted from the protocol; therefore, it could be implemented as a direct point-to-point wireless connection, or via a suitable network, such as a cellular telephone network. The client application interacts with an onboard processor to query information such as mileage statistics and maintenance information or to initiate vehicle controls such as, for instance, remote engine start and heater control. The processor interacts with onboard storage and vehicle sensors to execute the client-requested functions.

One illustrative application would be for a user to use a PDA to remotely start the vehicle's heater prior to leaving a restaurant or a movie theater. Another example would be for a user to use a laptop computer to gather mileage statistics for work-related expense reports, or for a vehicle owner to monitor speed, location, distance usage by anther person. Those practiced in the art will recognize, however, that the protocol described herein could be extended for use in non-automotive telematics applications, such as home appliances, to name only one representative example.

The following embodiments and aspects thereof are described and illustrated in conjunction with devices, systems, and methods which are meant to be exemplary and illustrative, not limiting in scope. In addition to the exemplary aspects and embodiments, further aspects and embodiments will become apparent by study of the following descriptions and by reference to the accompanying drawings.

### BRIEF DESCRIPTION OF THE DRAWINGS

Exemplary embodiments are illustrated in the referenced figures of the drawings. It is intended that the embodiments and figures disclosed herein be considered illustrative rather than limiting.

FIG. 1 diagrammatically illustrates a representative operating environment in which one or more embodiment(s) of a user-based telematics system can be implemented;

FIG. 2 represents a high level communications flow chart for the TAP communications system;

FIG. 3 illustrates a diagram of a representative general purpose computer system that may be configured to implement aspects of one or more described embodiments; and

FIG. 4 represents a packet diagram in accordance with the TAP format.

### DETAILED DESCRIPTION

In the following detailed description, reference is made to the accompanying drawings which form a part hereof, and in which is shown by way of illustrations certain exemplary embodiments.

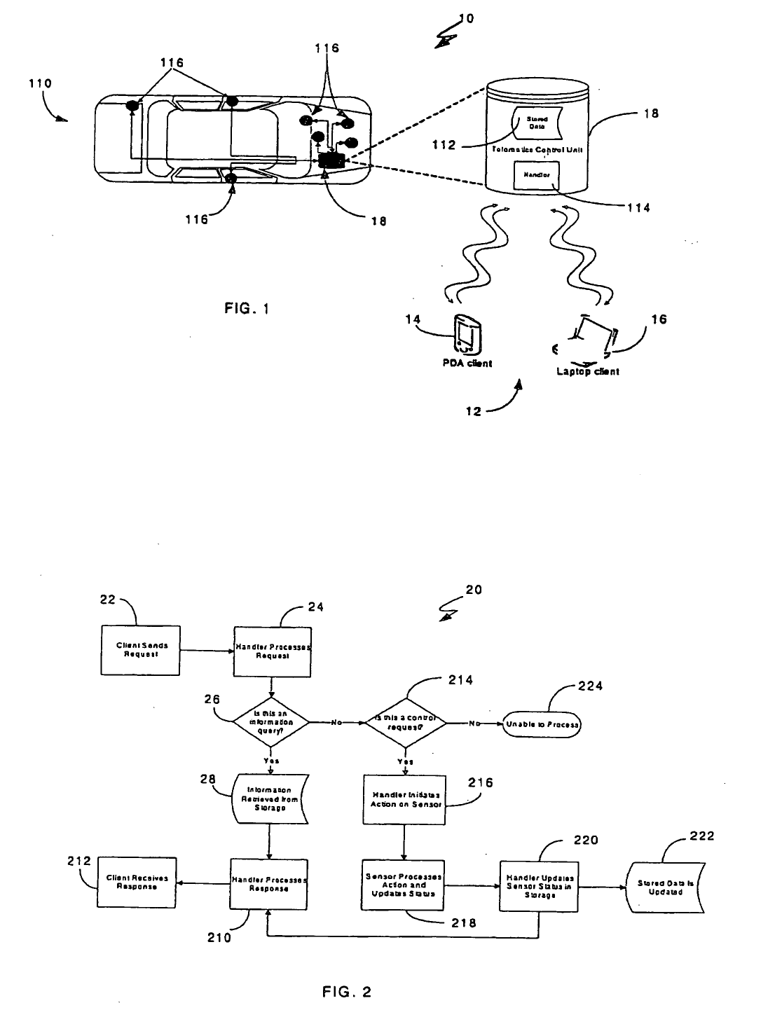

FIG. 1 depicts an exemplary architecture 10 for the TAP. According to the TAP architecture, at least one client (generally 12), namely a personal portable electronic device having wireless communications capabilities, such as a PDA 14 or a laptop computer 16, interacts with a telematics control unit (TCU) 18 to initiate controls and/or to query information regarding a target vehicle 110. The TCU 18 may be separate from or possibly integrated into the vehicle's onboard computer. In a preferred form, the TCU is a separate embedded system which interfaces with the vehicle's onboard computer, and it preferably contains an onboard storage unit 112 and a handler 114. Handler 114 receives requests from the client 12, sends responses to the client 12 based on client inquiries, sends control operations to the vehicle's sensors (generally 116), receives status from the sensors 116, and queries and updates the onboard storage unit 112.

Storage unit 112 is preferably a database containing records of vehicle information used to generate reports and statistics. The onboard storage unit 112 also maintains each sensor's status. To this end, it is contemplated that the sensors 116 are onboard devices which actively control various vehicle operations (e.g., the door locks, the heater, the windows, the trunk, etc.) or passively gather vehicle information (e.g., onboard GPS data, mileage, fluid levels, etc.). Preferably also, the system is capable of providing secure, direct communication between the remote user and the various onboard processing functions. In a preferred embodiment, all communications occur between the client 12 and the TCU handler 114. In this regard, the client 12 advantageously incorporates a set of predefined functions and does not communicate directly with the data storage unit 112 or the sensors 116.

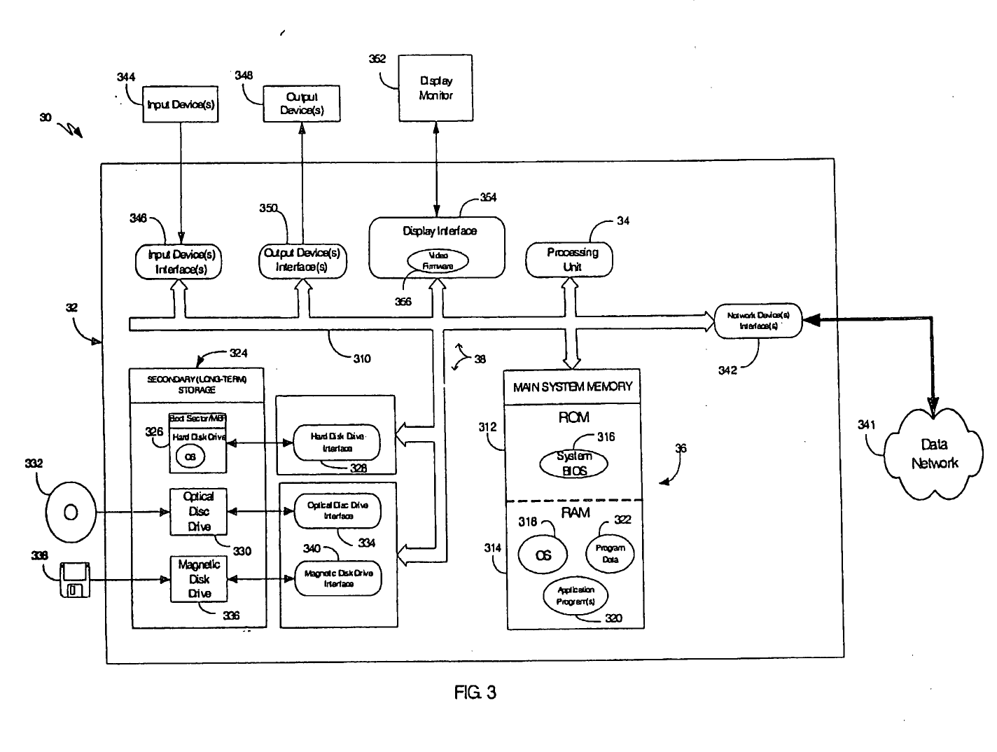

FIG. 2 represents a flowchart 20 for the request and response processes for the TAP and its associated components. When a client 12 initially sends a request at 22, it is processed by handier 114 at 24. If the client is requesting status information in response to inquiry 26 then this information is retrieved from the storage unit 112 at 28. The handler then processes a response 210 which is received by the client at 212.

If, on the other hand, the client 12 issuing a command to control an aspect of the vehicle, then flow proceeds instead from 214 to 216 for the handler to initiate action on one or more sensors. Each sensor processes the requested action and then updates its status which is sent to the handler and placed in storage at 220, whereby the stored data is updated at 222. The handler also processes a response for the client 210 which is received as before at 212. Of course, if for some reason the transmitted signal from the client is not interpreted by the handler as either a query or a control request, then no processing takes place as indicated at 224.

Embodiments of illustrative computing environments for implementing the aspects associated with a client, such as client 16 in FIG. 1, will be described with reference to FIG. 3. Computing environment 30 may utilize a general purpose computer system 32 for executing applications in accordance with the described teachings. System 32 includes a processing unit 34 (e.g., a CPU), a system memory 36 and an input output (I/O) system, generally 38. These various components are interconnected by a system bus 310 which may be any of a variety of bus architectures. System memory 36 may include both non-volatile read only memory (ROM) 312 and volatile memory such as static or dynamic random access memory (RAM) 314. Programmable read only memories (PROMs), erasable programmable read only memories (EPROMs) or electrically erasable programmable read only memories (EEPROMs) may be provided. ROM portion 312 stores a basic input/output system (the system BIOS) as shown. RAM portion 314 stores an operating system (OS) 318, one or more application programs 320, and program data 322. Computer system 32 may be adapted to execute in any of the well-known operating system environments, such as Windows, UNIX, MAC-OS, 0S2, PC-DOS, DOS, etc.

Various types of storage devices can be provided as more permanent data storage areas which can be either read from or written to, such as contemplated by secondary (long term) storage 324. Such devices may, for example, include a non-removable, non-volatile storage device in the form of a large-capacity, hard disk drive 326 which is connected to the system bus 310 by a hard disk drive interface 328. Hard disk drive 326 includes at least one bootable disk which stores the OS that is loaded into RAM 314 during a booting sequence.

An optical disk drive 330 for use with a removable optical disk 332, such as a CD-ROM, DVD-ROM or other optical media, may also be provided and interfaced to system bus 310 by an associated optical disk drive interface 334. Computer system 32 may also have one or more magnetic disk drives 336 for receiving removable storage such as a floppy disk or other magnetic media 338 which itself is connected to system bus 310 via magnetic disk drive interface 340. Optical media such as 332 and magnetic media such as 338 represent removable, non-volatile storage devices. Remote storage over a network is also contemplated.

One or more of the memory or storage regions mentioned above may comprise suitable media for storing programming code, data structures, computer-readable instructions or other data types for the computer system 32. Such information is then executable by processor 34 so that the computer system 32 can be configured to embody the capabilities described herein. Alternatively, the software may be distributed over an appropriate communications interface so that it can be installed on the user's computer system.

System 32 may be adapted to communicate with a data distribution network 341 (e.g., LAN, WAN, the Internet, etc.) via communication link(s) so that, for instance, it can communicate with a service provider. Establishing the network communication is aided by one or more network device interface(s) 342, such as a network interface card (NIC), a modem or the like which is suitably adapted for connection to the system bus 310. System 32 preferably also operates with various input and output devices as part of I/O system 38. For example, user commands or other input data may be provided by any of a variety of known types of input devices 344 (e.g. keyboard, pointing device, etc.) having associated input interface(s), generally 346. One or more output devices 348 (e.g. printer, fax, etc.) with associated interfaces, generally 350, may also be provided. A monitor 352 or other suitable display device is provided and may be connected to the system bus 310 by a suitable display adapter 354 (i.e., video card) having associated video firmware 356.

Although certain aspects for a client computer system may be preferred in the illustrative embodiments, the present invention is not limited as to the type of computers on which it can be implemented, and it should be readily understood that the present invention indeed contemplates use in conjunction with any appropriate information processing device (IPD) having the capability of being configured in a manner for accommodating the invention. Moreover, it should be recognized that the invention could be adapted for use on computers other than general purpose computers, as well as on general purpose computers without conventional operating systems.

The TAP involves connection-oriented, asynchronous interactions in a request-response format. It is designed to work at the application layer of the TCP/IP stack and preferably uses TCP for reliability and connection control. TAP exchanges messages, which are defined as structured data exchanged between loosely coupled systems. In the classic client/server model the client sends a request and the server sends a response. In TAP every request has an associated response in a one-to-one relationship. Since it is built on the TCP/IP stack, TAP can use transport layer security (TLS) for authentication and privacy.

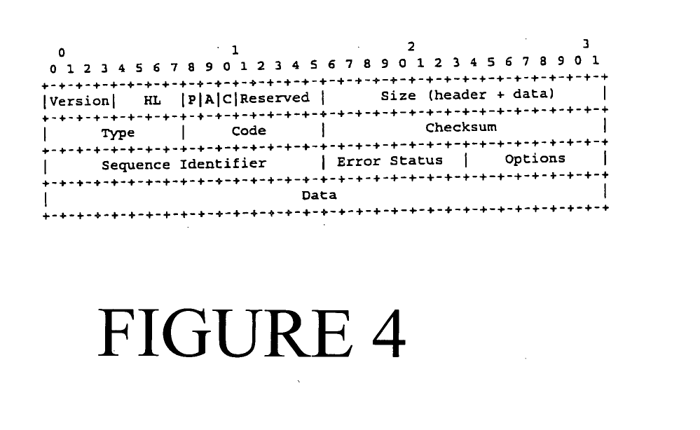

FIG. 4 represents the TAP format 40 which includes a header portion 42 and a data portion 44. Table 1 is provided below for an understanding of the protocol components within the various fields that comprise the TAP's header portion 42.

| Name | Description | Value |
|---|---|---|
| Version | Version of the protocol | 1 |
| Header length | Number of 32-bit words | 3 |
| | forming the header | |
| Privacy flag | Set to 1 to denote encryption | 0 or 1 |
| | was used to protect privacy | |
| Authentication flag | Set to 1 to denote | 0 or 1 |
| | authentication was used to | |
| | protect the authenticity of this | |
| | message | |
| Category | Set to 0 to identify the action | 0 or 1 |
| | as a request and 1 for a | |
| | response | |
| Reserved | Flags reserved for future use | 0 |
| Size | Size of the message in bytes | N/A |
| | (header + data) | |
| Type | The action type. Examples | 1-255 |
| | are GPS, Maintenance | |
| | diagnostic sensors, or Control | |
| | Operations. | |
| Code | Identifies the specific action | 1-255 |
| | for the request or response per | |
| | the Type setting. | |
| Checksum | The 16-bit one's complement | 0 or value |
| | of the one's complement sum | |
| | of all 16-bit words in the | |
| | header. The checksum field | |
| | should be set to zero before | |
| | generating the checksum | |
| Sequence Identifier | A number used to associate | N/A |
| | requests with responses | |
| Error status | Set by response operation, | 0 or value |
| | otherwise 0 | |
| Options | Reserved for future use | 0 |
| Data | Contains the data specific to | Variable |
| | the message type indicated by | |
| | the Type and Code fields | |

Those practiced in the art should appreciate that the TAP is designed with extensibility and can be suitably customized to provide additional functionality via the reserved bits and options fields, 46 and 48 respectively, in FIG. 4. The protocol allows for an open framework with type and code parameters, associated respectively with fields 410 and 412, which can be tailored to accommodate a wide variety of devices. Additional parameters are carried in the data portion 44 of the protocol, which is of variable length and can be customized per application, thus allowing for other extended uses of the TAP.

Examples of requests and responses for each of these possible Type options, namely GPS, Maintenance diagnostics, and Control operations, are set forth herein, for a protocol format such as that illustrated in FIG. 4. It will be appreciated that these examples are merely illustrative, as are the specific Type options, and not intended to limit the invention in any way.

Type 1—GPS

Code 1—Cumulative miles

Cumulative miles can be reported per trip. The parameters for this request include a single date, a date range, a list of comma delimited dates, or 0 for all dates. The response includes the cumulative miles relative to the provided parameters. The following is an example request:

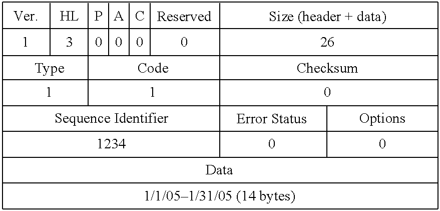

The following is an example response:

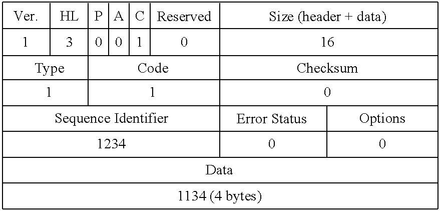

Code 2—Areas Covered

Areas covered can be reported per trip. The parameters for this request include a single date, a date range, a list of comma delimited dates, or 0 for all dates. The response includes cities and states relative to the provided parameters. The following is an example request:

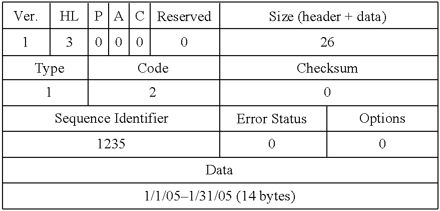

The following is an example response:

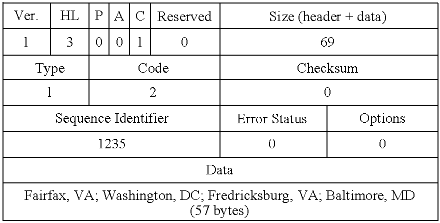

Code 3—Average Speed

Average speed can be reported per trip. The parameters for this request include a single date, a date range, a list of comma delimited dates, or 0 for all dates. The response includes an integer representing the average speed relative to the provided parameters. The following is an example request:

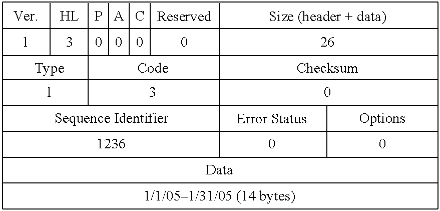

The following is an example response:

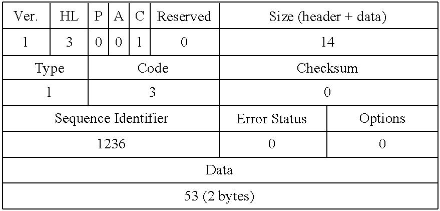

Code 4—Average Miles Per Day

Average miles per day can be reported per trip. The parameters for this request include a single date, a date range, a list of comma delimited dates, or 0 for all dates. The response includes an integer representing the average miles per day relative to the provided parameters. The following is an example request:

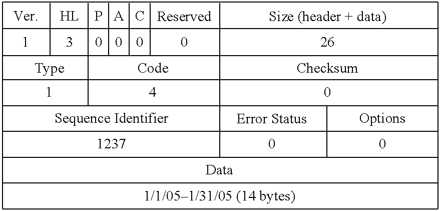

The following is an example response:

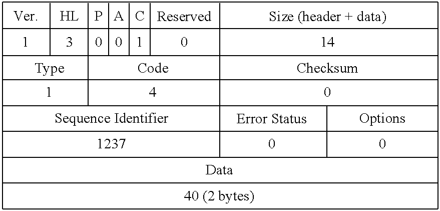

Code 5—Length of Travel

Length of travel can be reported per trip. The parameters for this request include a single date, a date range, a list of comma delimited dates, or 0 for all dates. The response includes a total time in hours and minutes relative to the provided parameters. The following is an example request:

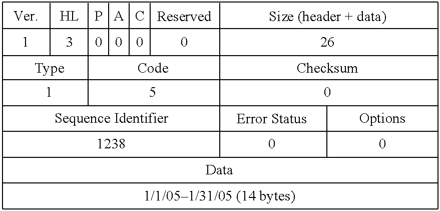

The following is an example response:

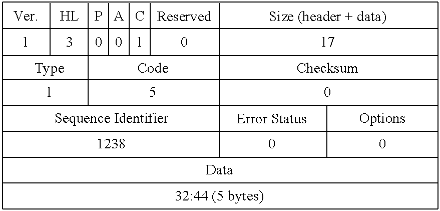

Code 6—Average Travel Time Average travel time can be reported per trip. The parameters for this request include a single date, a date range, a list of comma delimited dates, or 0 for all dates. The response includes an average time in hours and minutes relative to the provided parameters. The following is an example request:

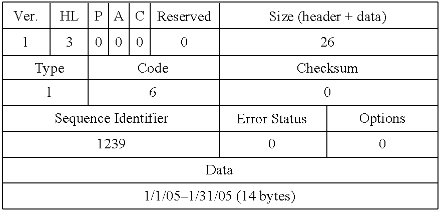

The following is an example response:

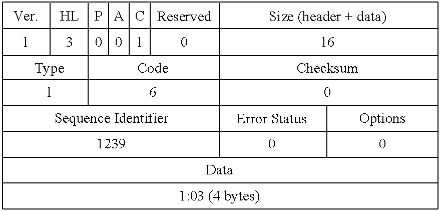

Code 7—Vehicle Location

Vehicle location can be reported in real time. The parameter for this request is a simple 0. The response includes the GPS coordinates in latitude and longitude and approximate city location if available. The following is an example request:

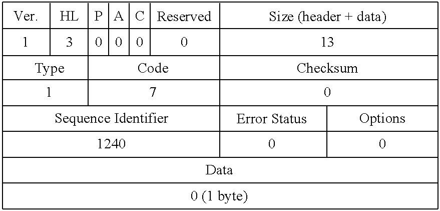

The following is an example response:

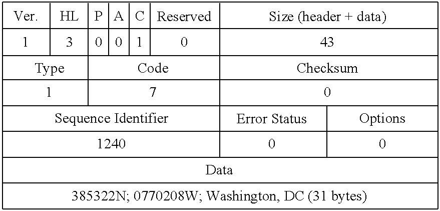

Type 2—Maintenance Diagnostic Sensors
Code 1—Wiper Status

Wiper status can be reported in terms of last installation date and change status. The parameter for this request is a simple 0. The response includes the last date of change and the change status: Good, Fair, Poor. The following is an example request:

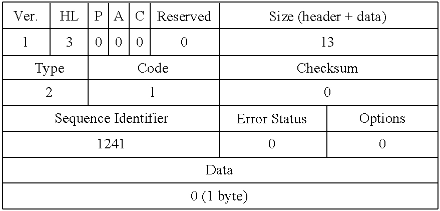

The following is an example response:

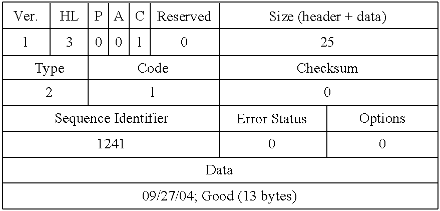

Code 2—Oil Status

Oil status can be reported in terms of last oil change date and change status. The parameter for this request is a simple 0. The response includes the last date of change and the change status: Good, Fair, Poor. The following is an example request:

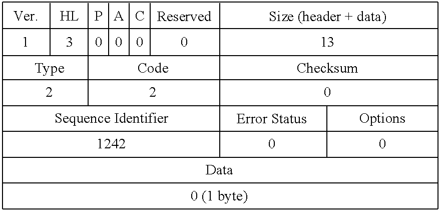

The following is an example response:

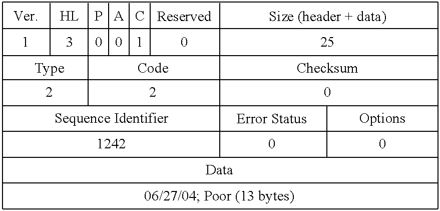

Fluid status can be reported on various fluids in terms of last change date and change status. The parameter for this request depends on the fluid being queried [e.g. 1—brake, 2—windshield, 3—power steering, 4—radiator], or 0 for all fluids. The response includes the last date of change and the change status: Good, Fair, Poor. The following is an example request:

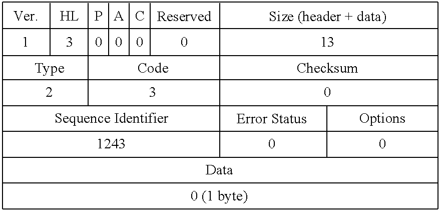

The following is an example response:

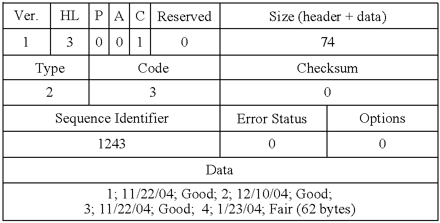

Code 4—Tire Pressure

Tire Pressure is reported for each tire. The parameter for this request is a simple 0. The response includes the tire pressure in PSI for each tire in the format front right (FR), front left (FL), back right (BR), and back left (BL). The following is an example request:

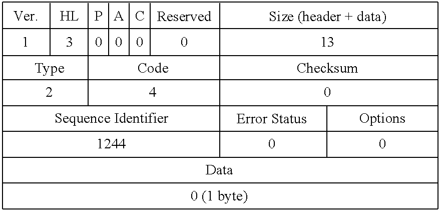

The following is an example response:

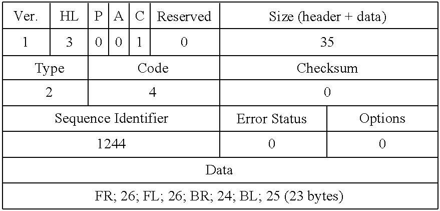

Code 5—Tire Mileage

Tire Mileage indicates how many miles have been traveled on each tire. The parameter for this request is a simple 0. The response includes the tire mileage for each tire in the format front right (FR), front left (FL), back right (BR), and back left (BL). The following is an example request:

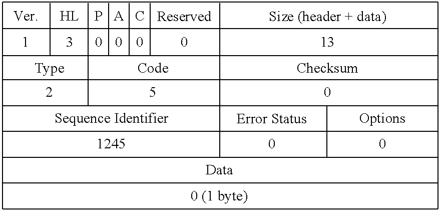

The following is an example response:

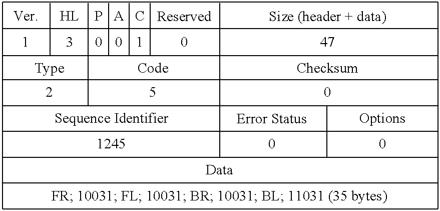

Type 3—Control Operations
Code 1—Engine Start/Stop

Engine control allows the user to start and stop the engine. The parameter for this request is a 0 for start and a 1 for stop. The response includes a status confirmation with a 0 for start and a 1 for stop. The following is an example request:

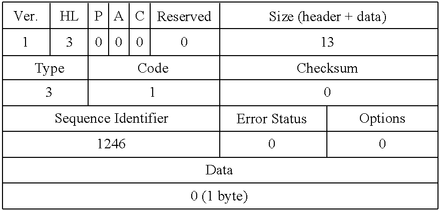

The following is an example response:

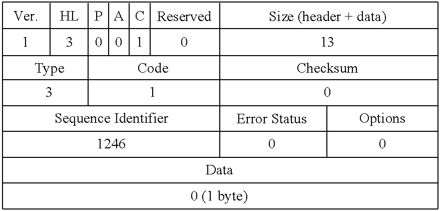

Code 2—Heat Start/Stop Heater control allows the user to start and stop the heater and adjust the temperature. The parameter for this request is a 0 for start and a 1 for stop. Another optional request parameter is temperature. If a temperature is not supplied the default of 72 will be used. The response includes a status confirmation with a 0 for start and a 1 for stop. This control is also used to adjust the temperature even after the heater is started. The following is an example request:

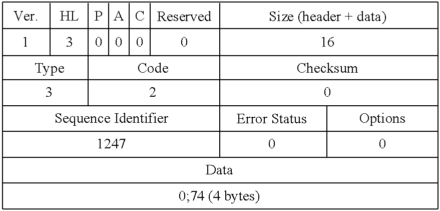

The following is an example response:

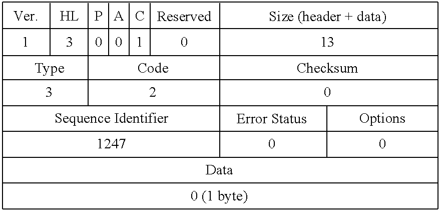

Code 3—Air Conditioning Start/Stop

Air Conditioning (AC) control allows the user to start and stop the AC and adjust the temperature. The parameter or this request is a 0 for start and a 1 for stop. Another optional request parameter is temperature. If a temperature is not supplied the default of 72 will be used The response includes a status confirmation with a 0 for start and a 1 for stop. This control is also used to adjust the temperature even after the AC is started. The following is an example request:

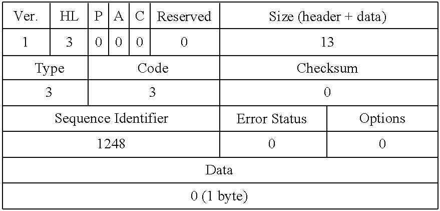

The following is an example response:

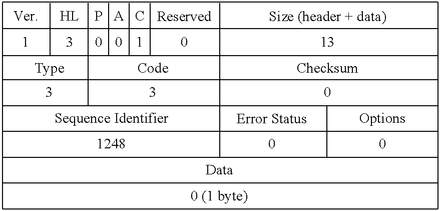

Code 4—Heated Seats Start/Stop

Heated seats control allows the user to start and stop the heated seats for the driver and passenger seats. The parameter for this request is a 0 for start and a 1 for stop for the drivers seat (D) and passengers seat (P) or all seats (A). The response includes a status confirmation with a 0 for start and a 1 for stop. The following is an example request:

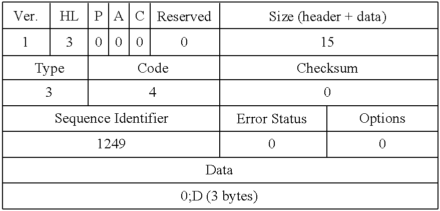

The following is an example response:

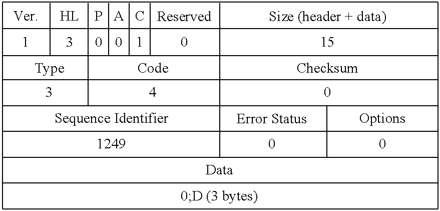

Code 5—Door Lock Control

Door lock control allows the user to lock and unlock the doors. The parameter for this request is a 0 for lock and a 1 for unlock for each vehicle door [e.g. 1—Driver, 2—Passenger, 3—Back right, 4—Back left, 0—All]. The response includes a status confirmation with a 0 for lock and a 1 for unlock. The following is an example request:

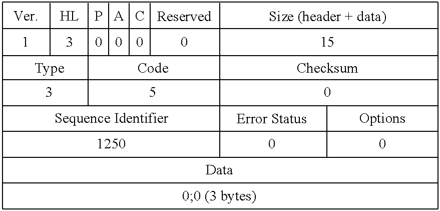

The following is an example response:

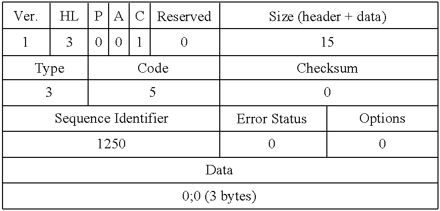

Accordingly, the present invention has been described with some degree of particularity directed to certain exemplary embodiments. Those of skill in the art, though, will recognize that certain modifications, permutations, additions and sub-combinations thereof are within the true spirit and scope of the various embodiments.

What is claimed is:

1. A telematics system that provides an individual user with the ability to monitor and manage a remote device, comprising:
at least one control element on said remote device that performs at least one of the functions of monitoring a condition of the device and controlling a state of the device;
a telematics control unit on said remote device that communicates with said control element; and
a portable personal electronic device that communicates with said remote device via a wireless medium by means of a protocol in which a request packet is transmitted to said telematics control unit to perform one of said functions and, in response to each request packet, said telematics control unit returns a response packet with the result of the requested function.

2. The telematics system of claim 1, wherein said protocol operates at the application layer of a TCP/IP stack.
